(19) United States
(12) Patent Application Publication
(10) Pub. No.: US 2009/0027179 A1
(43) Pub. Date: Jan. 29, 2009

(54) Auxiliary Device for Handling a Vehicle

(75) Inventors: Joachim Gloger, Bibertal (DE); Christian Toepfer, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChysler AG, Stuttgart (DE)

(21) Appl. No.: 11/661,447

(22) PCT Filed: Aug. 25, 2005
(86) PCT No.: PCT/EP05/09159

§ 371 Date: Mar. 21, 2008

(30) Foreign Application Priority Data
Sep. 1, 2004 (DE) 102004042281.8

(51) Int. Cl. B60Q 1/00

(52) U.S. Cl. 340/435

(57) ABSTRACT

A device for assisting in handling a vehicle having a sensing system for sensing the surroundings of the vehicle, a processing unit for processing the data collected by the sensing system, and a visual display device for displaying the collected data. In order to provide an auxiliary device for handling a vehicle with a sensing system, a processing unit and a visual display unit which makes the vehicle more comfortable to handle and reliably prevents collisions with obstacles, it is proposed that the sensing system senses both the surroundings of the vehicle and the vehicle itself and said vehicle is represented with the surroundings on the display device, it being possible to add additional lines for supporting the handling of the vehicle to the display device.

### BACKGROUND AND SUMMARY OF THE INVENTION

This application claims the priority of German patent document 10 2004 042 281.8, filed Sep. 1, 2004 (PCT International Application No. PCT/EP2005/009159, filed Aug. 25, 2005), the disclosure of which is expressly incorporated by reference herein.

The invention relates to a device for assisting in the handling of a vehicle.

Devices for monitoring the surroundings of a vehicle are known. For example, German patent document DE 201 05 340 U1 discloses a device for the three-dimensional sensing of the surroundings of road vehicles, (in particular, for detecting parking spaces), which has a distance sensor that generates a sequence of distance profiles, a data processing unit and a memory unit. A three-dimensional image of the environment surrounding the vehicle is composed by the data processing unit.

German patent document DE 100 35 223 A1 discloses a device for monitoring the surroundings of a vehicle which has a plurality of sensing devices, an evaluation unit and a visual display device. The evaluation device and the sensing devices are used to generate an image which represents the surroundings of the vehicle.

One object of the present invention is to provide an auxiliary device for handling a vehicle, comprising a sensing system, a processing unit and a visual display unit which makes the vehicle more comfortable to handle and reliably avoids collisions with obstacles.

This and other objects and advantages are achieved by the vehicle handling assistance apparatus according to the invention, which includes a sensing system for sensing the surroundings of the vehicle, a processing unit for processing data collected by the sensing system, and a visual display device for displaying the collected data to a vehicle occupant. An on-board computer can be used, for example, as the processing unit. According to the invention, the sensing system senses both the surroundings of the vehicle and the vehicle itself. Both the surroundings and the vehicle itself are represented using the visual display device. In addition, it is also possible to add additional lines, which support the handling of the vehicle, to the optical display device.

The representation of the vehicle and the surroundings supports the handling of the vehicle to a considerable degree, in particular reversing and the movement of parts of the vehicle, but also the normal straight-ahead travel of the vehicle, depending on the position of the sensing system. This applies in particular because generally movements play a large role in the handling of a vehicle. If the vehicle is represented with its surroundings, it is possible to estimate particularly satisfactorily how the vehicle is moving relative to its surroundings and whether problems, for example collisions, can occur in the process.

The sensing system can be composed of one assembly. This provides advantages in particular for the manufacture and mounting since only one unit has to be mounted. It has proven particularly advantageous if the sensing system senses a range of 360°. In this case, the area of a vehicle of interest can be sensed and displayed using a sensing system without costly systems for superimposing various sensing systems being necessary.

The sensing system may comprise a 360° camera. A camera records its surroundings optically and can therefore be represented on the visual display device without complex conversions. Of course, other sensing systems such as, for example, infrared sensing systems, acoustic systems or radar systems, are also possible. In these cases, the processing unit or the display unit must be correspondingly adapted.

The sensing system according to the invention can be arranged, for example, in the region of the rear of the vehicle. This region of a vehicle is of interest in particular in large vehicles such as trucks or vans because it is difficult for the driver to see. This applies particularly to moving the vehicle backward and moving parts which are attached to the vehicle, for example the opening of the doors.

If the sensing system is 360° camera arranged in the upper region of the rear part of the vehicle, it records a region which is of particular interest to the driver, specifically both the roof of the vehicle and the rear portal of the vehicle as well as the surroundings adjacent to these regions of the vehicle. The roof of the vehicle can be of interest if the driver moves under an object (for example a bridge) with the vehicle. By using the auxiliary device according to the invention it is possible to estimate in a particularly simple way how the roof relates to its surroundings, here the bridge, in particular whether traveling through can lead to a collision. The same applies to the rear portal when the vehicle moves backward and to the opening of parts attached to the rear portal, for example doors.

The visual display device can be a monitor, which is particularly favorable because it is an element which has become customary in vehicle construction. It has proven advantageous to arrange the monitor in the region of the interior mirror because in this region it can be seen conveniently by the driver. For reversing this positioning has the advantage that the driver can see the interior mirror and the monitor at a glance.

It is possible to provide additional lines, which characterize boundaries of the vehicle, on the visual display device which represents the data collected by the sensing system. This is advantageous if the visual display device does not provide a clear representation of the collected data due to unfavorable light conditions, for example. If, for example, the vehicle is moving under a bridge in the dark, the sensing system may not clearly sense the boundary line of the vehicle before the background of dark surroundings. The additional line that characterizes the boundary line of the vehicle then helps the driver to determine without doubt where the vehicle ends, and to estimate whether it is moving relative to its surroundings in such a way that a collision will not occur.

It is also possible to add further lines that characterize regions into which the vehicle and/or parts of the vehicle may move. For example, additional lines may characterize the opening region of the doors. In this way, the driver can see at a glance whether, with respect to objects located in the surroundings of the vehicle, the vehicle assumes a position which permits unimpeded opening of doors. In the same way it is possible to add lines which characterize a driving corridor into which the vehicle may move. It has proven particularly advantageous to vary the driving corridor as a function of vehicle parameters. For example, the driving corridor can vary as a function of the steering angle which is set at the steering wheel.

Other objects, advantages and novel features of the present invention will become apparent from the following detailed description of the invention when considered in conjunction with the accompanying drawings.

### BRIEF DESCRIPTION OF THE DRAWINGS

FIG. 1 is an image of a vehicle and its surroundings generated on a monitor using the auxiliary device according to the invention;

FIG. 2 is an image according to FIG. 1 with an additional line that characterizes a boundary line of the vehicle;

FIG. 3 is an image according to FIG. 1 with an additional line that characterizes an opening region of doors;

FIG. 4 is an image according to FIG. 1 with additional lines that characterize the driving corridor of the vehicle;

FIG. 5 is an image according to FIG. 1 with additional lines that characterize a driving corridor of the vehicle which is coupled to the steering angle; and

FIG. 6 is a schematic block diagram of the vehicle operation assistance device according to the invention.

### DETAILED DESCRIPTION OF THE DRAWINGS

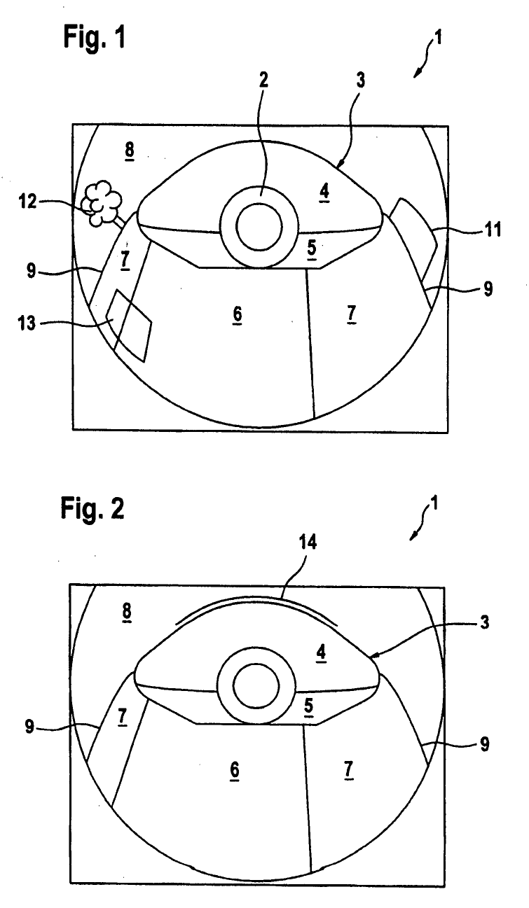

FIG. 1 illustrates a monitor 1 which represents an image generated using an auxiliary device according to the invention for handling a vehicle. (The illustrated image is explained in more detail below.) The sensing system which is used to generate the image comprises a 360° camera, such as is known from the prior art, which records everything located around it at a radius of 360°. The attachment device 2 for attaching the camera to the vehicle can be seen in FIG. 1.

Only a portion of the 360° image generated by the camera is represented on the monitor 1 in FIG. 1. The upper region of the image is not represented on the monitor, because the information in this region (for example, the sky) is not of interest to the handling of the vehicle. It is possible to configure the visual display of the auxiliary device according to the invention so that the driver can always cause precisely that section which is of interest to him to be displayed on the monitor 1. The vehicle 3 on which the camera is mounted can be seen around the attachment device 2 of the camera. The camera is mounted at the rear upper end of the vehicle so that with a 360° photograph it records both the roof 4 and the rear 5 of the vehicle. (In the case of a transporter this is then the rear portal 5.) The camera thus senses, in the first instance, the vehicle 3 which is carrying it.

The camera also senses the surroundings of the vehicle. FIG. 1 illustrates, for example, the surroundings schematically. The road 6 extends behind the vehicle 3 (that is, adjacent to the rear 5 of the vehicle). From the image it is apparent that the vehicle 3 is located at the right hand edge of the road 6. To the right and left of the road there are respectively side strips 7 which are delimited from the sky 8 by a horizontal line 9.

The displayed image also shows, a house 11 and a tree 12, which are both arranged on the horizon, and can be seen in schematic form. In the left lower region of the image there is a schematic representation of an obstacle (for example a vehicle) 13, which is to be taken into account when the vehicle 3 moves backward.

FIG. 2 shows a further line 14 in addition to the image represented in FIG. 1. The further line 14, which can be added or switched off depending on the driver's preferences, is arranged in the region of the roof 4 and indicates the extent of the vehicle 3 in the upward direction. By using the further line 14 for the height of the vehicle it is possible for the driver to estimate better how said further line 14 behaves compared to elements occurring in the surroundings, for example a bridge. In this way the driver can estimate more easily whether the vehicle will fit through the bridge. The height of the vehicle which is included in the display in the case of entries and passages with limited height indicates to the driver whether he can travel through without a collision.

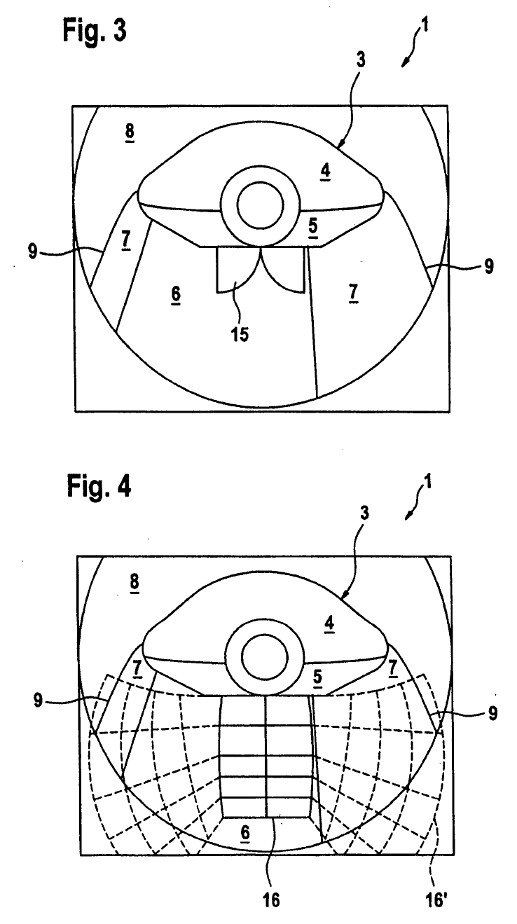

Further lines 15 which characterize the opening region of rear doors are added in FIG. 3. With the addition of these lines, the driver can assess in the cockpit whether it is possible to open the rear doors in the current position of the vehicle or whether the vehicle has to be moved.

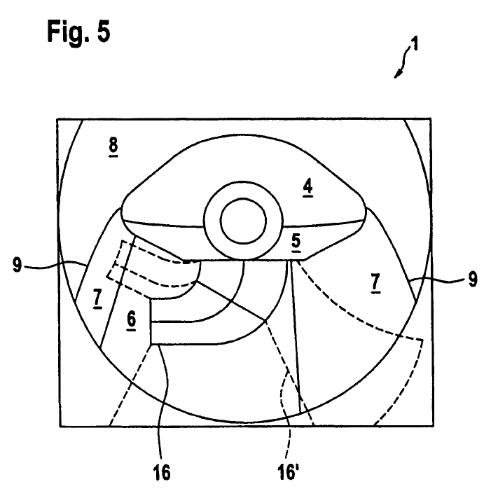

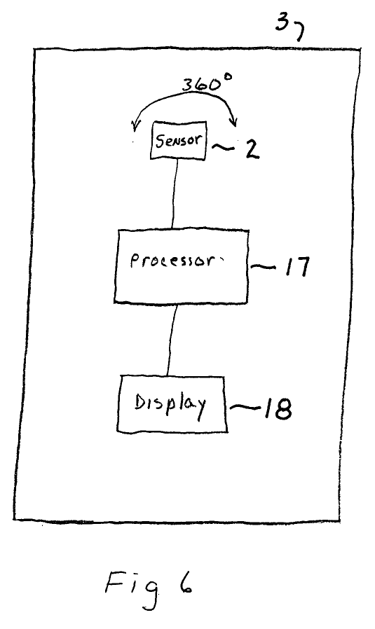

Further lines 16 and 16′ which are added in the illustration in FIG. 4 indicate a downward directed driving corridor for the vehicle. The continuous additional lines 16 characterize here the region on the ground, while the dashed additional lines 16′ mark the region above the ground. The driving corridor which is superimposed on the camera makes maneuvering and parking easier for the driver. This applies in particular if the additional lines 16 and 16′ which indicate the driving corridor are coupled to the steering wheel angle of the vehicle, as illustrated in FIG. 5. The driver can thus monitor precisely the region into which he will move his vehicle.

FIG. 6 is a schematic block diagram that illustrates the vehicle handling assistance apparatus according to the invention. A vehicle 3 has a sensing system 2 mounted thereon, which as noted previously may comprise a 360° camera. Image data of the vehicle and its surrounding environment are collected by the sensor system 2 and sent to a processor 17, which includes software for generating the visual images as depicted in FIGS. 1-5. Images generated by the process 17 are displayed by the display unit 18, which may be in the form of a monitor.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. Apparatus for assisting in handling a vehicle, said apparatus comprising:
a sensing system for sensing surroundings of the vehicle;
a processing unit for processing the data collected by the sensing system; and
a visual display device for displaying the collected data; wherein
the sensing system senses both the vehicle surroundings and the vehicle itself; and
the vehicle is represented with the surroundings on the display device; and
the processor includes means for displaying additional lines for supporting the handling of the vehicle to the display device.

13. The device as claimed in claim 12, wherein the sensing system comprises a unit and senses a range of 360°.

14. The device as claimed in claim 12, wherein the sensing system is a 360° camera.

15. The device as claimed in claim 12, wherein the sensing system is arranged in a rearward region of the vehicle.

16. The device as claimed in claim 15, wherein the sensing system senses both the roof and a rear portion of the vehicle, as well as surroundings adjacent to the rearward regions of the vehicle.

17. The device as claimed in claim 12, wherein the visual display device is a monitor which is arranged proximate to an interior mirror of the vehicle.

18. The device as claimed in claim 12, wherein the additional lines represent boundary lines of the vehicle.

19. The device as claimed in claim 12, wherein the additional lines indicate regions into which the vehicle and/or parts of the vehicle may move.

20. The device as claimed in claim 12, wherein the additional lines indicate an opening region of the doors.

21. The device as claimed in claim 12, wherein the additional lines indicate a driving corridor into which the vehicle may move.

22. The device as claimed in claim 21, wherein the additional lines which represent the driving corridor are variable as a function of vehicle parameters.

23. The device as claimed in claim 22, wherein said vehicle parameters comprise a steering wheel angle of the vehicle.
